(19) United States
(12) Patent Application Publication
(10) Pub. No.: US 2026/0104831 A1
(43) Pub. Date: Apr. 16, 2026

(54) IMAGE FORMING APPARATUS, CONTROL METHOD, AND NON-TRANSITORY COMPUTER-READABLE RECORDING MEDIUM

(71) Applicant: KONICA MINOLTA, INC., Tokyo (JP)

(72) Inventor: Takatsugu KUNO, Toyokawa-shi (JP)

(73) Assignee: KONICA MINOLTA, INC., Tokyo (JP)

(21) Appl. No.: 19/341,679

(22) Filed: Sep. 26, 2025

(30) Foreign Application Priority Data
Oct. 15, 2024 (JP) 2024-179861

(51) Int. Cl. G06F 3/12; H04L 9/40; H04N 1/00

(52) U.S. Cl. CPC G06F 3/1238; G06F 3/1204; G06F 3/1222; G06F 3/1231; G06F 3/1255; H04L 63/0876; H04N 1/00854; G06F 3/1286; H04N 2201/0094

(57) ABSTRACT

An image forming apparatus that performs user authentication based on authentication information added to a print job, and permits printing based on the print job when the user authentication is successful. The image forming apparatus includes a hardware processor. The hardware processor acquires, when the authentication information is not added to a print job, device information indicating a transmission source of the print job, identifies a transmission user of the print job based on the device information, saves the print job as a pending job for the transmission user, releases a pending state of the pending job in a case where the user authentication of the transmission user is successful, and starts a print output of the print job.

### CROSS REFERENCE TO RELATED APPLICATIONS

The present application is based on Japanese Patent Application No. 2024-179861 filed on Oct. 15, 2024, the contents of which are incorporated herein by reference.

### BACKGROUND OF THE INVENTION

### Technical Field

The present invention relates to an image forming apparatus, a control method, and a non-transitory computer-readable recording medium.

### Description of Related Art

Conventionally, an apparatus that replaces a job of a guest user with a job of a registered user and executes the job has been proposed (e.g., Japanese Unexamined Patent Publication No. JP2022-45658A). When receiving a job to which authentication information is not added, this conventional apparatus specifies a user based on device information indicating a transmission source of the job. If the user can be identified, the conventional apparatus executes the received job as a job of the identified user.

However, in the above-described conventional technology, when a user can be specified, a job is executed without performing user authentication. Therefore, in the conventional apparatus, a job may be executed in an unauthorized manner due to spoofing of device information or the like, which is a security risk.

An image forming apparatus such as an MFP (Multifunction Peripheral) can enable an authentication setting for a received print job in order to improve security. When the authentication setting is enabled, the image forming apparatus performs user authentication based on authentication information added to a received print job, and permits printing when the user authentication is successful. As one of methods of adding authentication information to a print job, for example, there is a method of registering authentication information in a printer driver installed in a PC and automatically adding authentication information when the printer driver transmits a print job to an image forming apparatus.

However, when the authentication setting in the image forming apparatus is changed from disabled to enabled, or when the user's PC is replaced, the user may transmit a print job without registering authentication information in the printer driver. In this case, no authentication information is added to a print job to be transmitted to the image forming apparatus. If the authentication setting is enabled, the image forming apparatus discards the received print job if authentication information is not added to the received print job.

However, the user moves to an installation place of the image forming apparatus in order to obtain a printed material without noticing that the print job has been discarded at the image forming apparatus. Then, the user notices for the first time that the print job has been discarded in the image forming apparatus. In this case, the user has to return to the installation site of his/her own PC, add the authentication information to the same print job again, and transmit the print job, which results in poor workability.

On the other hand, as in the above-described conventional technology, when a user is specified based on device information added to a print job and the job is executed as a job of the specified user, there is a possibility that the job is illegally executed, which causes a security problem.

### SUMMARY OF THE INVENTION

The present invention has been devised in order to solve the above-described problems. That is, an object of the present invention is to provide an image forming apparatus, a control method, and a non-transitory computer-readable recording medium capable of suppressing a decrease in convenience due to discard of a job to which authentication information is not added, while reducing security risk.

One subject of the present invention is directed to an image forming apparatus that performs user authentication based on authentication information added to a print job, and permits printout based on the print job when the user authentication is successful. According to one aspect of the present invention, the image forming apparatus includes a hardware processor that acquires, when the authentication information is not added to a print job, device information indicating a transmission source of the print job, identifies a transmission user of the print job based on the device information, saves the print job as a pending job for the transmission user, releases a pending state of the pending job in a case where the user authentication of the transmission user is successful, and starts a print output of the print job.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of a configuration of a network system including an image forming apparatus;

FIG. 2 is a diagram illustrating an example of a hardware configuration of an image forming apparatus;

FIG. 3 is a diagram illustrating an example of user information;

FIG. 4A and FIG. 4B are diagrams illustrating an example of a print job that the image forming apparatus receives from the information processing apparatus when the authentication setting is enabled;

FIG. 5 is a block diagram illustrating a functional configuration of a controller in the image forming apparatus;

FIG. 6 is a diagram illustrating an example of setting items to be set by the setter and setting values thereof;

FIG. 7 is a flowchart illustrating an example of a processing procedure performed in the image forming apparatus;

FIG. 8 is a flowchart illustrating an example of a detailed processing procedure of the pending job saving processing; and

FIG. 9 is a flowchart illustrating a processing procedure when the image forming apparatus stores a pending job.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### Preferred Embodiment

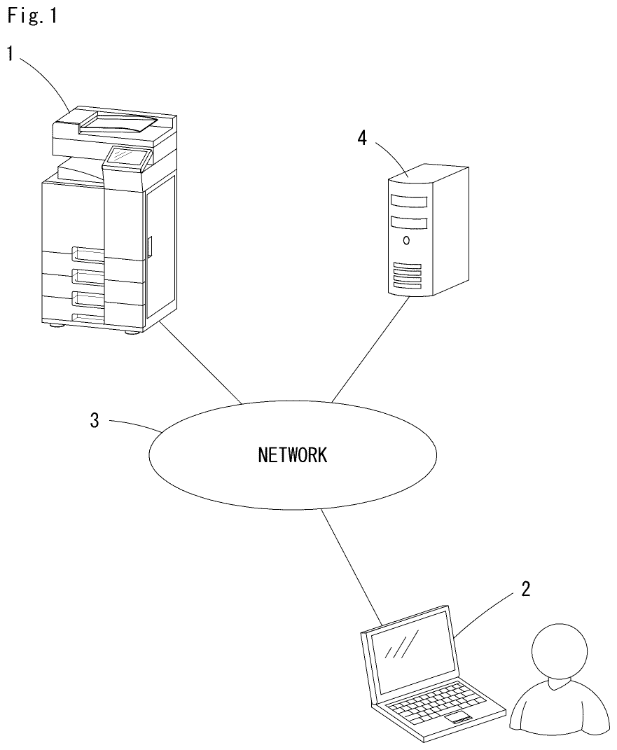

FIG. 1 illustrates an example of the configuration of a network system including an image forming apparatus 1 according to an embodiment of the present invention. This network system is, for example, a system constructed in an office environment. The network system has a configuration in which an image forming apparatus 1 and an information processing apparatus 2 are connected to a network 3 such as a local area network (LAN). FIG. 1 illustrates an example in which one information processing apparatus 2 is connected to the network 3. However, a plurality of information processing apparatuses 2 may be connected to the network 3. Furthermore, the network system may be configured to include a server apparatus 4 connected to the network 3.

The image forming apparatus 1 includes, for example, an MPF, and has a scanning function and a printing function. The image forming apparatus 1 receives the print job transmitted from the information processing apparatus 2 via the network 3. Upon receiving the print job, the image forming apparatus 1 forms an image on a sheet such as a printing sheet based on image data included in the print job, and outputs the sheet.

The information processing apparatus 2 is configured by, for example, a personal computer (PC). The information processing apparatus 2 is used by a user who works in an office. A printer driver for generating a print job to be transmitted to the image forming apparatus 1 is installed in the information processing apparatus 2. The information processing apparatus 2 activates a printer driver in accordance with a user operation and transmits a print job to the image forming apparatus 1.

The image forming apparatus 1 can enable an authentication setting for a received print job in order to improve security. When the authentication setting is enabled, the image forming apparatus performs user authentication based on authentication information added to a received print job, and performs printing and outputting on condition that the user authentication is successful. For example, the user can register authentication information in the printer driver of the information processing apparatus 2 in advance. In a case where user authentication information is registered, when generating a print job to be transmitted to the image forming apparatus 1, the printer driver automatically adds the authentication information to the print job. Therefore, when the authentication setting is enabled in the image forming apparatus 1, the user does not need to manually set the authentication information in the print job every time the print job is transmitted by registering the authentication information in the printer driver.

Further, in a case where the authentication setting is invalid, when the image forming apparatus 1 receives a print job, the image forming apparatus 1 executes print output based on the received print job regardless of whether or not authentication information is added to the print job. In this case, the user does not need to register his/her authentication information in the printer driver.

Further, when the authentication setting is enabled, the image forming apparatus 1 can set whether or not to permit the print output by the guest user. The guest user is a user who is not registered in the image forming apparatus 1. In a case where the print output by the guest user is permitted, when the image forming apparatus 1 receives the print job to which the authentication information is not added, the image forming apparatus 1 executes the print job as the print job of the guest user. When executing a print job of a guest user, the image forming apparatus 1 imposes a function restriction during print output. For example, even when color printing is designated in the print job, the image forming apparatus 1 restricts the function of color printing and executes monochrome printing.

In a case where the print output by the guest user is prohibited, when the image forming apparatus 1 receives the print job to which the authentication information is not added, the image forming apparatus 1 stores the print job as a pending job under a predetermined condition. Next, in a case where the user authentication for the pending job is successful, the image forming apparatus 1 reads the pending job and executes printing out.

The server apparatus 4 is provided as an authentication server, and executes user authentication when receiving an authentication request from the outside via the network 3. When performing user authentication, the image forming apparatus 1 may transmit an authentication request to the server apparatus 4 via the network 3 and receive an authentication result from the server apparatus 4. However, without being limited to this, the image forming apparatus 1 may be configured to execute all processing related to user authentication on its own without using the server apparatus 4.

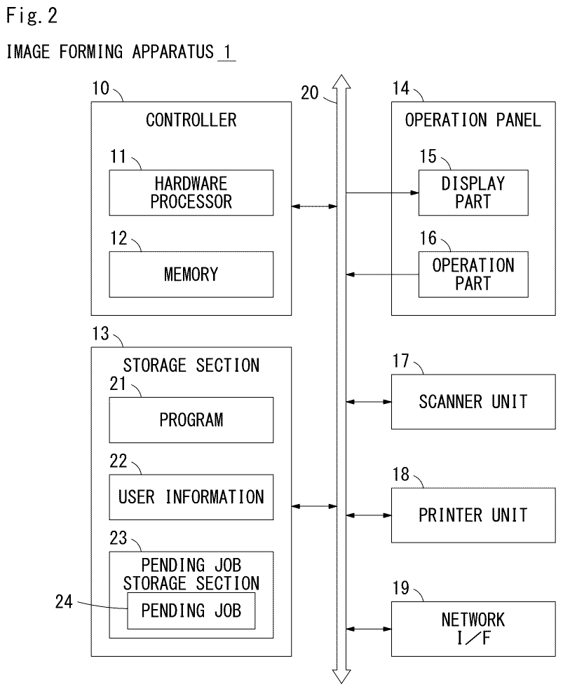

FIG. 2 is a diagram illustrating an example of a hardware configuration of the image forming apparatus 1. The image forming apparatus 1 includes a controller 10, a storage section 13, an operation panel 14, a scanner unit 17, a printer unit 18, and a network interface 19, which are connected to each other via a bus 20.

Controller 10 comprehensively controls operation in image forming apparatus 1. The controller 10 includes a hardware processor 11 and a memory 12. The hardware processor 11 reads and executes a program 21 stored in the storage section 13. The memory 12 stores temporary data and the like generated by the hardware processor 11 executing the program 21.

The storage section 13 is a nonvolatile storage device constituted by a hard disk drive (HDD), a solid state drive (SSD), or the like. The storage section 13 stores a program 21 to be executed by the hardware processor 11. Further, the storage section 13 stores user information 22. The user information 22 is information in which information on users who are permitted to use the image forming apparatus 1 is registered in advance. The storage section 13 is provided with a pending job storage section 23. The pending job storage section 23 is a storage area for storing a pending job 24.

The operation panel 14 is a user interface with which a user operates the image forming apparatus 1. The operation panel 14 includes a display part 15 and an operation part 16. The display part 15 is configured by, for example, a color liquid crystal display. The display part 15 displays various operation screens for receiving operations by the user. The operation part 16 includes, for example, touch screen keys arranged on the screen of the display part 15. The operation part 16 receives user's operations on various operation screens displayed on the display part 15.

The scanner unit 17 optically reads an image of a document and generates image data. For example, the scanner unit 17 operates when a scan job is executed in the image forming apparatus 1, and reads an image of a document.

The printer unit 18 forms an image on a sheet such as printing sheet and outputs the sheet. For example, the printer unit 18 operates when a print job is executed in the image forming apparatus 1. Then, the printer unit 18 conveys the sheets one by one, and prints and outputs an image to be printed on the sheet. For example, the printer unit 18 forms an image on a sheet by an electrophotographic method. However, the image forming method by the printer unit 18 is not limited to the electrophotographic method. For example, the printer unit 18 may form an image on a sheet by an inkjet method.

The network interface 19 is an interface for connecting the image forming apparatus 1 to the network 3. The controller 10 communicates with an external device via the network interface 19. For example, the controller 10 receives a print job transmitted from the information processing apparatus 2 via the network interface 19.

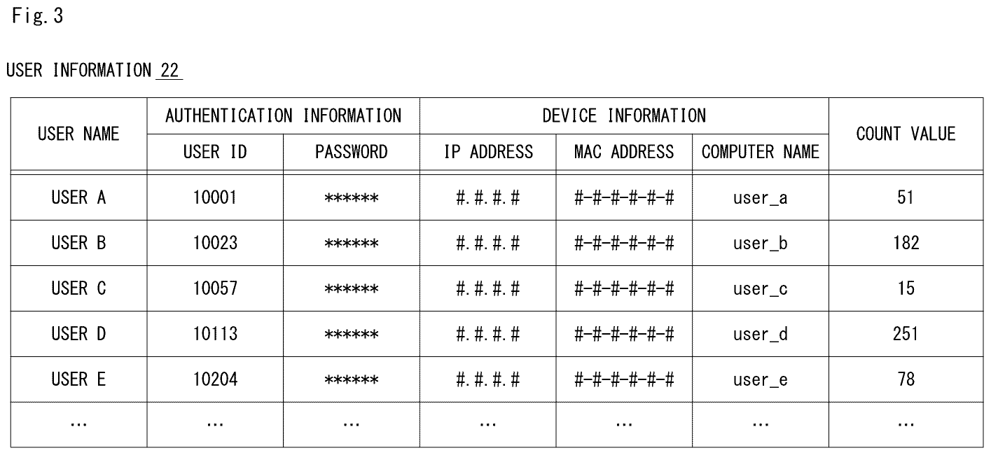

FIG. 3 is a view illustrating an example of the user information 22. As described above, the user information 22 is information in which information on users who are permitted to use the image forming apparatus 1 is registered. For example, information on a plurality of users is registered in the user information 22. The user information 22 is information in which authentication information, device information, and a count value are registered for each user. The authentication information is information used for user authentication. The authentication information includes, for example, a user ID and a password for each user. The device information is information for identifying the information processing apparatus 2 used by each user. For example, the device information is information including at least one of an IP address, a MAC address, and a computer name of the information processing apparatus 2. The count value is information in which a use record of the image forming apparatus 1 by each user is recorded. As the count value, for example, a value counted up by 1 each time one sheet is printed out is recorded.

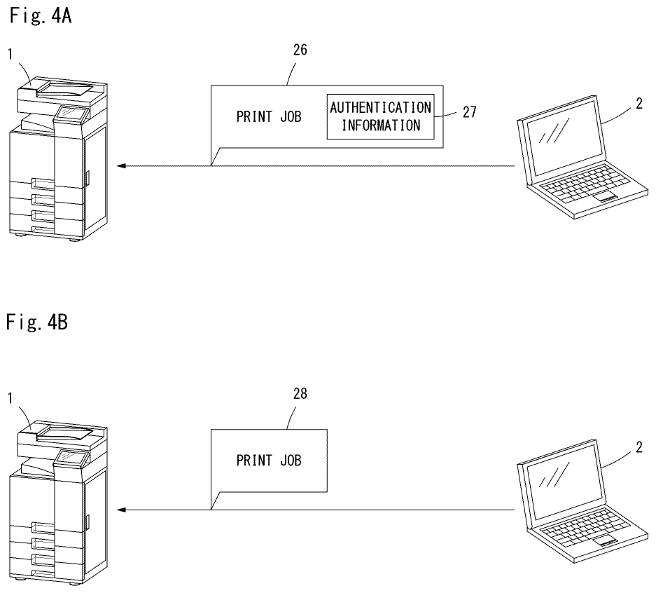

FIGS. 4A and 4B are diagrams illustrating examples of print jobs that the image forming apparatus 1 receives from the information processing apparatus 2 when the authentication setting is enabled. FIG. 4A illustrates an example in which the image forming apparatus 1 receives a print job 26 to which authentication information 27 has been added. The authentication information 27 includes, for example, a user ID and a password. Upon receiving the print job 26 to which the authentication information 27 is added, the image forming apparatus 1 performs user authentication based on the authentication information 27. For example, the image forming apparatus 1 performs user authentication by determining whether authentication information that matches the user ID and the password included in the authentication information 27 is registered in the user information 22. When the user authentication is successful, the image forming apparatus 1 identifies the user (transmission user) to whom the print job 26 has been sent, from among the users registered in the user information 22. Then, the image forming apparatus 1 executes the print job 26 and prints out the image designated as the print target. At this time, the image forming apparatus 1 executes the print job 26 in a state in which the print setting designated by the print job 26 is reflected.

On the other hand, if the user authentication fails, the image forming apparatus 1 cannot identify the transmission user of the print job 26. In this case, the image forming apparatus 1 discards the received print job 26.

FIG. 4B illustrates an example in which the image forming apparatus 1 receives a print job 28 to which authentication information is not added. For example, when the authentication setting of the image forming apparatus 1 is changed from invalid to valid, or when the information processing apparatus 2 used by the user is replaced, there is a possibility that the authentication information is not yet registered in the printer driver of the information processing apparatus 2. In such a case, the print job 28 to which the authentication information is not added may be transmitted from the information processing apparatus 2 of the authorized user registered in the user information 22 to the image forming apparatus 1.

When the authentication information is not added to the print job 28 received from the information processing apparatus 2 while the authentication setting is enabled, the image forming apparatus 1 determines whether printout by the guest user is permitted. When the print output by the guest user is permitted, the image forming apparatus 1 prints out the print job 28 as a job of the guest user. At this time, the image forming apparatus 1 executes the print job 28 in a state where the function restriction at the time of print output is imposed.

On the other hand, when the print output by the guest user is prohibited, the image forming apparatus 1 stores the print job 28 to which the authentication information is not added as a pending job. Next, when the user authentication for the pending job is successful, the image forming apparatus 1 reads and executes the pending job. Hereinafter, a detailed configuration example and an operation example of such an image forming apparatus 1 will be described.

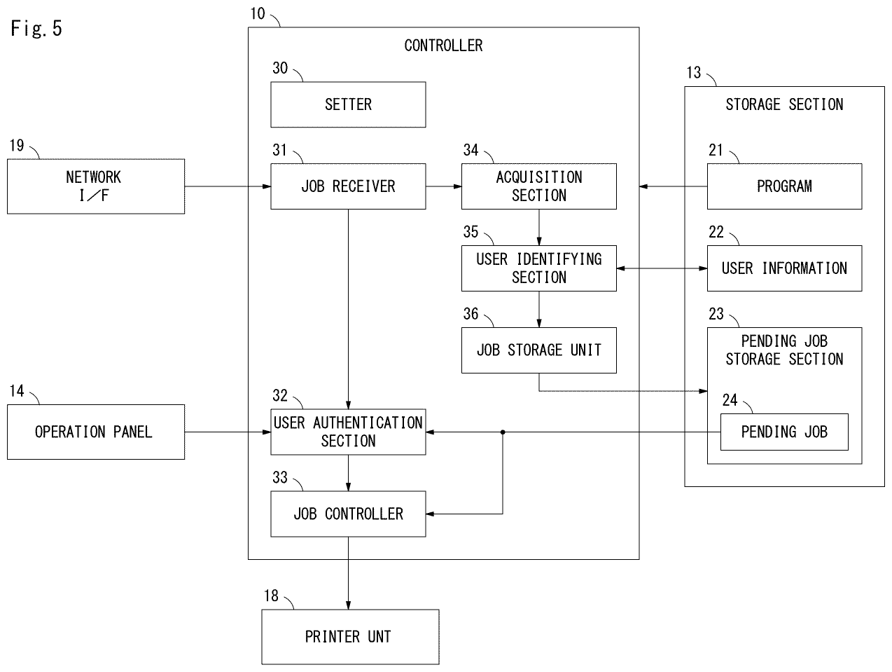

FIG. 5 is a block diagram illustrating the functional configuration of the controller 10 in the image forming apparatus 1. The hardware processor 11 executes the program 21 to cause the controller 10 to function as a setter 30, a job receiver 31, a user authentication section 32, a job controller 33, an acquisition section 34, a user identifying section 35, and a job storage unit 36.

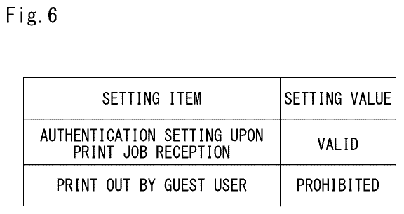

The setter 30 makes settings related to printing output of the image forming apparatus 1. FIG. 6 is a diagram illustrating an example of setting items set by the setter 30 and setting values thereof. The setting items set by the setter 30 include “authentication setting upon reception of print job” and “print output by guest user”. In the example of FIG. 6, “valid” is set in the setting item of “authentication setting at the time of print job reception”. Furthermore, in the example of FIG. 6, “prohibited” is set in the setting item of “print output by guest user”. When receiving the print job, the image forming apparatus 1 performs an operation according to the setting values of the setting items.

The job receiver 31 receives a print job via the network interface 19. In a case where the authentication setting at the time of reception of the printing job is enabled, when the job receiver 31 receives the printing job, the job receiver 31 determines whether or not authentication information is added to the received printing job. When the authentication information is added, the job receiver 31 outputs the authentication information added to the print job to the user authentication section 32.

Further, in a case where the print job to which the authentication information is not added is received when the authentication setting is valid, the job receiver 31 determines whether or not the print output by the guest user is permitted. When the print output by the guest user is permitted, the job receiver 31 outputs the received print job to the job controller 33. On the other hand, when printing by the guest user is prohibited, the job receiver 31 causes the acquisition section 34, the user identifying section 35, and the job storage unit 36 to function sequentially.

In a case where the authentication setting is valid, the user authentication section 32 executes user authentication for determining whether or not the received print job is a job by an authorized user. When authentication information is added to the received print job, the user authentication section 32 acquires the authentication information added to the print job. Next, the user authentication section 32 determines whether authentication information that matches the authentication information added to the print job is registered in the user information 22.

In a case where the same authentication information is registered in the user information 22, the user authentication by the user authentication section 32 is successful. That is, the user authentication section 32 can specify the transmission user of the print job from among the registered users in the user information 22. When succeeding in the user authentication, the user authentication section 32 outputs the received print job to the job controller 33.

The job controller 33 controls execution of a print job by driving the printer unit 18. For example, the job controller 33 starts feeding and conveying a sheet, and controls an operation of forming and outputting an image to be printed on the conveyed sheet. When the user authentication by the user authentication section 32 is successful and the print job is executed, the job controller 33 executes the print job while reflecting the print setting specified in the print job. Therefore, when the user authentication is successful and the print job is executed, the job controller 33 outputs a printed material intended by the user.

In contrast, when a print job is executed as a job by a guest user, the job controller 33 disables some of the function settings among the print settings specified in the print job, and executes the print job. For example, when color printing is designated in a print job to be executed as a job of a guest user, the job controller 33 disables the setting of color printing and performs monochrome printing to output an image. Therefore, when a print job is executed as a job of a guest user, the job controller 33 may not output a printed product intended by the user. Note that the function restriction when the job is executed as a job of a guest user is not limited to the restriction on color output. That is, the job controller 33 may impose a functional limitation other than the limitation on color output.

The acquisition section 34 functions in a case where a print job to which authentication information is not added when the authentication setting is enabled is received and print output by a guest user is prohibited. The acquisition section 34 acquires device information indicating a transmission source of a print job from information received together with the print job. For example, the acquisition section 34 acquires, from information included in header information or the like at the time of reception of a print job, device information such as an IP address, a MAC address, or a computer name indicating a transmission source. Upon acquiring the device information, the acquisition section 34 outputs the device information to the user identifying section 35.

The user identifying section 35 searches the device information registered in the user information 22 on the basis of the device information acquired by the acquisition section 34 and identifies the user who has transmitted the print job. That is, the user identifying section 35 determines whether device information that matches the device information acquired by the acquisition section 34 is registered in the user information 22. For example, when an IP address, a MAC address, and a computer name are included in the device information, the user identifying section 35 determines whether or not at least one of the IP addresses, the MAC address, and the computer name matches.

As a result, when device information that matches the device information acquired by the acquisition section 34 is registered in the user information 22, the user identifying section 35 can identify the user on the basis of the device information registered in the user information 22. The user identified based on the device information is a transmission user of the print job. Therefore, the user identifying section 35 can specify the transmission user of the print job based on the device information.

On the other hand, device information that matches the device information acquired by the acquisition section 34 may not be registered in the user information 22. In that case, the user identifying section 35 cannot identify the user who has sent the print job even by searching the user information 22. If the transmission user cannot be identified even by searching the user information 22, the user identifying section 35 inquires of the outside about the user of the device information via the network interface 19. For example, the user identifying section 35 sends an e-mail describing the device information to the administrator of the image forming apparatus 1 to inquire of the administrator about the user of the device information. The user identifying section 35 may transmit an inquiry command to which the device information is added to the external server apparatus 4 to inquire of the server apparatus 4 about the user of the device information.

When an inquiry about the user of the device information is made to the outside, the user identifying section 35 obtains a response to the inquiry from the outside. The response may include user information indicating the user of the device information or may not include the user information. For example, if the administrator or the server apparatus 4 is able to identify the user of the device information, it adds the user information to a response to the inquiry. On the other hand, when the administrator or the server apparatus 4 cannot identify the user of the device information, the administrator or the server apparatus 4 does not add the user information to the response to the inquiry.

In a case of acquiring user information as a response to the inquiry, the user identifying section 35 registers the user indicated by the user information and the device information in the user information 22 in an associated manner. For example, the user identifying section 35 determines whether the user indicated by the user information is a registered user in the user information 22. If the user is a registered user, the user identifying section 35 changes the device information on the registered user in the user information 22 to the device information acquired by the acquisition section 34 and registers the device information. Note that if the user indicated by the user information is not a registered user, the user identifying section 35 might not register the device information acquired by the acquisition section 34 in the user information 22.

When the user indicated by the user information is a registered user in the user information 22, the user identifying section 35 identifies the registered user as the transmission user of the print job. Furthermore, when the user indicated by the user information is an unregistered user in the user information 22, the user identifying section 35 does not identify the user who has transmitted the print job.

When the user identifying section 35 can specify the transmission user of the print job, the user identifying section 35 brings the job storage unit 36 into operation. In contrast, if the user identifying section 35 cannot identify the user who has transmitted the print job, the user identifying section 35 discards the received print job.

The job storage unit 36 sets the received print job as the pending job 24 of the transmission user, and saves the pending job 24 in the pending job storage section 23. In other words, the job storage unit 36 stores and manages the print job to which the authentication information is not added as the pending job 24 without discarding the print job.

When the pending job 24 is stored by the job storage unit 36, the user authentication section 32 functions in the controller 10. The user authentication section 32 displays, on the operation panel 14, an authentication information input screen on which the user can input authentication information such as a user ID and a password. When authentication information is input in the authentication information input screen, the user authentication section 32 executes user authentication. That is, the user authentication section 32 determines whether or not the authentication information input to the operation panel 14 matches the authentication information registered in the user information 22.

When the authentication information matches, the user authentication by the user authentication section 32 is successful. That is, the user authentication section 32 can identify the user operating the operation panel 14 from among the registered users in the user information 22. Next, the user authentication section 32 notifies the job controller 33 of the identified user.

The job controller 33 determines whether the pending job 24 for the user identified by the user authentication section 32 is stored in the pending job storage section 23. When the pending job 24 of the identified user is stored, the job controller 33 reads the pending job 24 of the identified user from the pending job storage section 23. Next, the job controller 33 executes the read pending job 24, and prints out the job. At this time, the job controller 33 executes the pending job 24 while reflecting the print settings specified in the pending job 24. Therefore, when the user authentication is successful and the pending job 24 is executed, the job controller 33 outputs a printed material intended by the user.

In addition, a plurality of pending jobs 24 of the user specified by the user authentication section 32 may be stored in the pending job storage section 23. In that case, the job controller 33 sequentially reads the plurality of pending jobs 24, and sequentially executes the plurality of pending jobs 24. However, the present invention is not limited thereto, and in a case where the user designates the pending job 24 one by one and performs the input operation of the authentication information, the job controller 33 may read and execute the pending job 24 designated by the user one by one.

When the authentication information input to the operation panel 14 by the user does not match the authentication information registered in the user information 22, the user authentication by the user authentication section 32 fails. In this case, the job controller 33 does not read the pending job 24. Therefore, printout based on the pending job 24 is not performed.

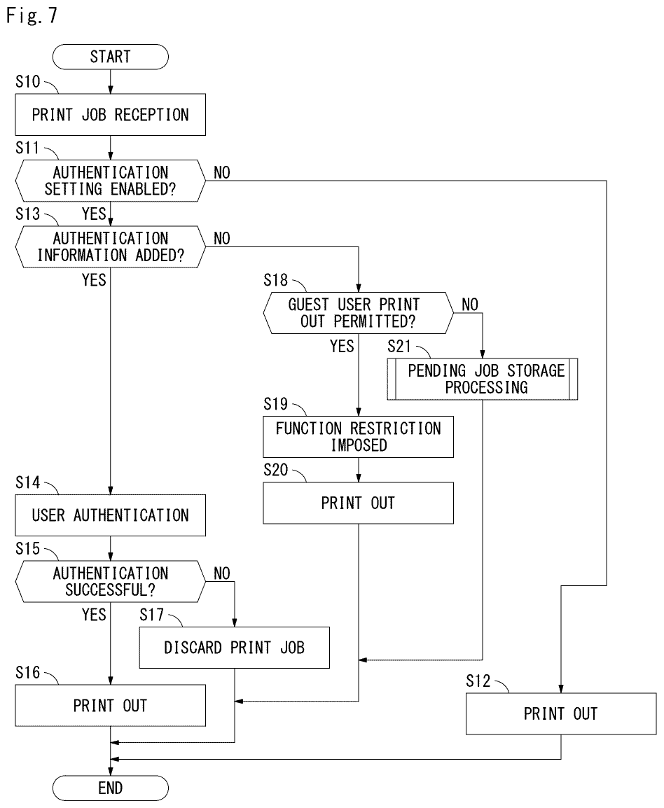

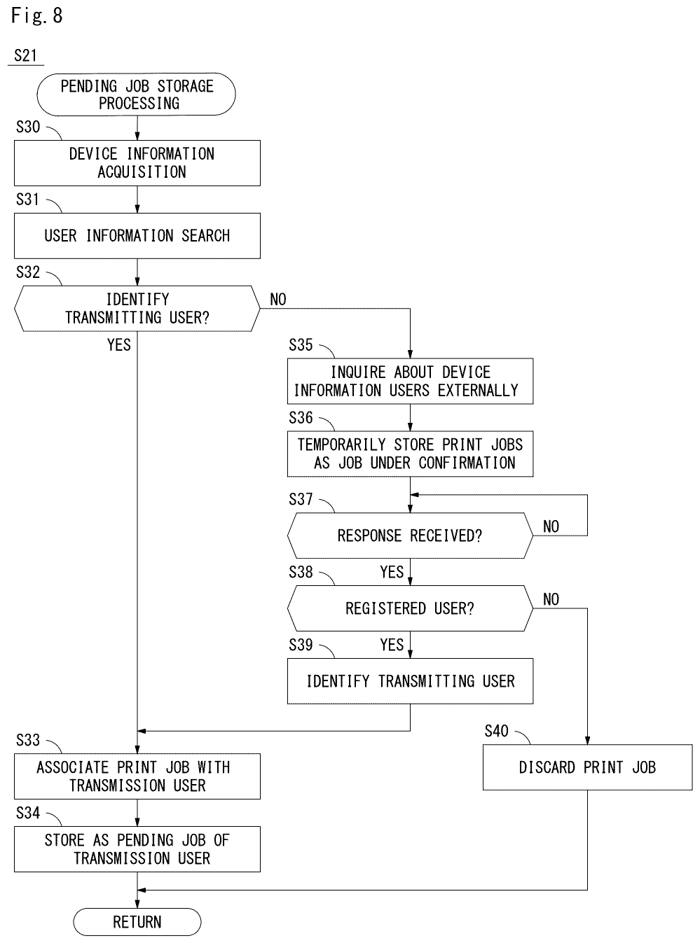

Next, operations of the image forming apparatus 1 will be described. FIGS. 7 and 8 are flowcharts illustrating an example of a processing procedure performed in the image forming apparatus 1. Specifically, FIGS. 7 and 8 show a processing procedure when the image forming apparatus 1 receives a print job. This processing procedure is performed by, for example, the hardware processor 11 executing the program 21.

The image forming apparatus 1 receives the print job via the network 3 (step S10). When receiving the print job, the image forming apparatus 1 determines whether or not the authentication setting for the print job is valid (step S11). If the authentication setting is disabled (NO in step S11), the image forming apparatus 1 executes the received print job, and prints and outputs an image on a sheet based on the image date included in the print job (step S12).

If the authentication setting is enabled (YES in step S11), the image forming apparatus 1 determines whether authentication information is appended to the received print job (step S13). If the authentication information is added (YES in step S13), the image forming apparatus 1 performs user authentication (step S14). At this time, the image forming apparatus 1 determines whether authentication information that matches the authentication information added to the print job is registered in the user information 22. The image forming apparatus 1 then determines whether the authentication is successful (step S15). If the authentication is successful (YES in step S15), the image forming apparatus 1 executes the received print job and performs printout based on the print job (step S16). Thus, the user can obtain an intended printed material from the image forming apparatus 1.

In contrast, if the authentication has failed (NO in step S15), the image forming apparatus 1 discards the received print job without executing the print job (step S17). Thus, the image forming apparatus 1 can prevent unauthorized use by an unknown user.

If the authentication setting is enabled (YES in step S11) and no authentication information is appended to the received print job (NO in step S13), the image forming apparatus 1 determines whether printout by the guest user is permitted (step S18). When the print out by the guest user is permitted (YES in step S18), the image forming apparatus 1 imposes the function restriction at the time of the print out (step S19). Then, the image forming apparatus 1 performs printout based on the received print job in a state where the functional restriction is applied (step S20). Thus, the print job is executed as a job of the guest user in the image forming apparatus 1, and is printed out in a state where the function restriction is imposed.

If printout by the guest user is prohibited (NO in step S18), the image forming apparatus 1 executes pending job storage processing (step S21).

FIG. 8 is a flowchart illustrating an example of a detailed processing procedure of the pending job saving processing (step S21). When starting the pending job saving process, the image forming apparatus 1 acquires the apparatus information at the time of receiving the print job (step S30). The image forming apparatus 1 searches for the user information 22 on the basis of the device information (step S31). That is, the image forming apparatus 1 determines whether device information that matches the acquired device information is registered in the user information 22. In a case where the device information that matches the acquired device information is registered in the user information 22, the image forming apparatus 1 can specify the transmission user of the print job based on the device information. Therefore, the image forming apparatus 1 determines whether the user who has transmitted the print job can be identified as a result of searching the user information 22 (step S32).

If the transmission user can be identified (YES in step S32), the image forming apparatus 1 associates the received print job with the transmission user (step S33). Then, the image forming apparatus 1 stores the received print job in the pending job storage section 23 as the pending job 24 of the transmission user (step S34).

On the other hand, when the transmission user cannot be specified (NO in step S32), the image forming apparatus 1 inquires of the outside about users of the device information (step S35). In response to the inquiry from the outside, the image forming apparatus 1 temporarily stores the print job as a job under confirmation (step S36). The area for temporary storage may be the pending job storage section 23 or another storage area. Then, the image forming apparatus 1 waits until a response to the query is received (step S37).

Upon receiving a response to the query (yes in step S37), the image forming apparatus 1 determines, based on the response, whether or not the user of the device information is a registered user registered in the user information 22 (step S38). If the user of the device information is a registered user (YES in step S38), the image forming apparatus 1 identifies the registered user as the user who has transmitted the print job (step S39). Then, the image forming apparatus 1 associates the received print job with the transmission user (step S33), and stores the received print job in the pending job storage section 23 as the pending job 24 of the transmission user (step S34).

If the user of the device information is not a registered user (NO in step S38), the image forming apparatus 1 discards the received print job (step S40). Therefore, the image forming apparatus 1 can prevent the print job from being executed by an unauthorized user.

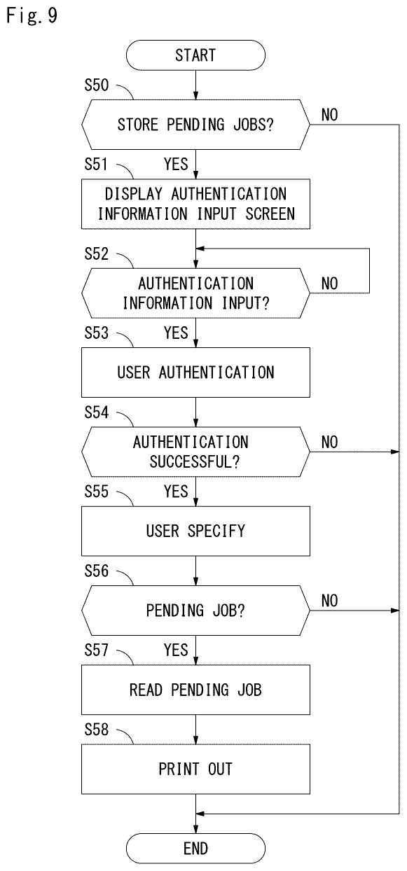

FIG. 9 is a flowchart illustrating an example of another processing procedure performed in the image forming apparatus 1. Specifically, FIG. 9 illustrates a processing procedure when the image forming apparatus 1 stores a pending job 24. This processing procedure is performed by, for example, the hardware processor 11 executing the program 21.

When starting this process, the image forming apparatus 1 determines whether or not the pending job 24 is stored (step S50). When the pending job 24 is not stored (NO in step S50), the processing by the image forming apparatus 1 is terminated. On the other hand, when the pending job 24 is stored (YES in step S50), the image forming apparatus 1 displays an authentication information input screen on the operation panel 14 (step S51).

For example, when the user moves to the installation location of the image forming apparatus 1 in order to obtain a printed material, if the user notices that the printed material is not output, the user performs an operation on the operation panel 14. Next, the user inputs his/her own authentication information to the authentication information input screen of the operation panel 14.

The image forming apparatus 1 waits until authentication information is input by the user (step S52). When the authentication information is input by the user, the image forming apparatus 1 performs user authentication (step S53). That is, the image forming apparatus 1 determines whether authentication information that matches the authentication information input by the user is registered in the user information 22. As a result, when authentication information that matches the authentication information input by the user is registered in the user information 22, the user authentication is successful. The image forming apparatus 1 determines whether the authentication has succeeded (step S54). If the user authentication has failed (NO in step S54), the process by the image forming apparatus 1 ends. In this case, the saved state of the pending job 24 continues.

On the other hand, when the user authentication is successful (YES in step S54), the image forming apparatus 1 identifies, based on the user information 22, the user who has input the authentication information (step S55). The image forming apparatus 1 determines whether the pending job 24 for the user identified in the user authentication is stored in the pending job storage section 23 (step S56). As a result, when the pending job 24 of the identified user is not saved (NO in step S56), the processing by the image forming apparatus 1 ends.

Furthermore, when the pending job 24 of the identified user is saved (YES in step S56), the image forming apparatus 1 reads the pending job 24 of the identified user from the pending job storage section 23 (step S57). Then, the image forming apparatus 1 performs printout based on the read pending job 24 (step S58). Note that the image forming apparatus 1 preferably deletes the pending job 24 from the pending job storage section 23 after printing out.

As described above, the image forming apparatus 1 of the present embodiment performs user authentication based on the authentication information added to the print job in a case where the authentication setting is enabled, and permits printout based on the print job in a case where the user authentication is successful. However, the image forming apparatus 1 may receive a print job to which authentication information is not added. In that case, the image forming apparatus 1 acquires device information indicating the transmission source of the print job, and specifies the transmission user of the print job based on the device information. Then, the image forming apparatus 1 stores the received print job as a pending job of the transmission user. In a case where the user authentication of the transmission user is successful in a state where the pending job is stored, the image forming apparatus 1 releases the pending state of the pending job and starts the print output.

Upon identifying the transmission user of the print job based on the device information, the image forming apparatus 1 having the above-described configuration does not immediately execute the print job of the transmission user, but executes the printout based on the pending job on condition that the user authentication of the transmission user is successful. Therefore, the image forming apparatus 1 can prevent a job from being fraudulently executed by spoofing or the like.

Further, when the user who has transmitted the print job moves to the installation location of the image forming apparatus 1 in order to acquire the printed material, the user notices that the print job is not executed. At this time, if the transmission user operates the operation panel 14 to input his or her own authentication information, the transmission user can execute the print job at that timing. Therefore, the user who has transmitted the print job does not needs to return to the installation location of his/her own information processing apparatus 2, add authentication information to the same print job again, and transmit the print job. Therefore, the image forming apparatus 1 of the present embodiment can improve the convenience of the user when the authentication information is not added.

### Modification Example

A preferred embodiment of the present invention has been described above. However, the present invention is not limited to the content described in the above embodiment, and various modification examples are applicable.

For example, in the above-described embodiment, the case where the image forming apparatus 1 is configured as an MFP has been exemplified. However, the image forming apparatus 1 is not limited to one configured as an MFP. For example, the image forming apparatus 1 may be a printer having only a print function.

In the above-described embodiment, the example in which the user ID and the password are included in the authentication information has been described. However, the authentication information may include information other than the user ID and the password. For example, the image forming apparatus 1 can perform card authentication or biometric authentication as a method of performing user authentication. In that case, the authentication information is configured as information including card information and biological information.

In the above-described embodiment, an example in which the program 21 to be executed by the hardware processor 11 is stored in the storage section 13 in advance has been described. However, the program 21 is not limited to a program stored in the storage section 13 in advance. That is, the program 21 can be a target of transaction by itself. Therefore, the program 21 may be provided in a state of being recorded on a computer-readable recording medium. Furthermore, the program 21 may be provided in a downloadable form via a network such as the Internet.

Although embodiments of the present invention have been described and illustrated in detail, the disclosed embodiments are made for purposes of illustration and example only and not limitation. The scope of the present invention should be interpreted by terms of the appended claims.

What is claimed is

1. An image forming apparatus that performs user authentication based on authentication information added to a print job, and permits printing based on the print job when the user authentication is successful, the image forming apparatus comprising a hardware processor that:
acquires, when the authentication information is not added to a print job, device information indicating a transmission source of the print job;
identifies a transmission user of the print job based on the device information;
saves the print job as a pending job for the transmission user;
releases a pending state of the pending job in a case where the user authentication of the transmission user is successful; and
starts a print output of the print job.

2. The image forming apparatus according to claim 1, wherein
the hardware processor presets permission or prohibition of the print output by a guest user, and when the print output by the guest user is prohibited, the hardware processor acquires the device information.

3. The image forming apparatus according to claim 1, further comprising:
a storage section that stores user information in which the device information is registered for each user, wherein
the hardware processor refers to the user information to identify the transmission user.

4. The image forming apparatus according to claim 3, wherein
authentication information for each user is further registered in the user information, and
the hardware processor releases the pending state of the pending job in a case where user authentication of the transmission user is successful based on the authentication information registered in the user information.

5. The image forming apparatus according to claim 3, wherein
when the device information is not registered in the user information, the hardware processor inquires of the outside about a user of the device information, and specifies the transmission user on the basis of an answer from the outside.

6. The image forming apparatus according to claim 5, wherein
the hardware processor registers the device information in the user information when the answer regarding the user of the device information is obtained from the outside.

7. The image forming apparatus according to claim 5, wherein
the hardware processor discards the print job when the answer regarding the user of the device information is not obtained from the outside.

8. The image forming apparatus according to claim 1, wherein
the device information is information including any of an IP address, a MAC address, and a computer name.

9. A control method for an image forming apparatus that performs user authentication based on authentication information added to a print job and permits printout based on the print job when the user authentication is successful, the control method comprising:
acquiring device information indicating a transmission source of the print job when the authentication information is not added to the print job;
identifying a transmission user of the print job based on the device information;
saving the print job as a pending job for the transmission user;
releasing a pending state of the pending job in a case where the user authentication of the transmission user is successful; and
starting a print output of the print job.

10. The control method according to claim 9, wherein
the control method includes presetting permission or prohibition of the print output by a guest user, and when the print output by a guest user is prohibited, the control method acquires the device information.

11. The control method according to claim 9, wherein
the control method stores user information in which the device information is registered for each user in a predetermined storage section, and
the control method refers to the user information to identify the transmission user.

12. The control method according to claim 11, wherein
authentication information for each user is further registered in the user information, and
the control method releases the pending state of the pending job in a case where user authentication of the transmission user has succeeded based on the authentication information registered in the user information.

13. The control method according to claim 11, wherein
when the device information is not registered in the user information, the control method inquires of the outside about a user of the device information, and specifies the transmission user on the basis of an answer from the outside.

14. The control method according to claim 13, wherein
the control method registers the device information in the user information when the answer about the user of the device information is obtained from outside.

15. The control method according to claim 13, wherein
the control method discards the print job when the answer about the user of the device information is not obtained from an outside.

16. The control method of claim 9, wherein
the device information is information including any of an IP address, a MAC address, and a computer name.

17. A non-transitory computer-readable recording medium storing a program to be executed in a hardware processor of an image forming apparatus that performs user authentication based on authentication information added to a print job and permits printout based on the print job when the user authentication is successful, wherein the program causes the hardware processor to perform:
acquiring device information indicating a transmission source of the print job when the authentication information is not added to the print job;
identifying a transmission user of the print job based on the device information;
saving the print job as a pending job for the transmission user;
releasing a pending state of the pending job in a case where the user authentication of the transmission user is successful; and
starting a print output of the print job.
